(19) United States
(12) Patent Application Publication
(10) Pub. No.: US 2025/0043187 A1
(43) Pub. Date: Feb. 6, 2025

(54) METHODS FOR MITIGATING 1,4-DIOXANE AND 1,4-DIOXANE PRECURSORS IN SURFACTANT SOLUTIONS

(71) Applicant: Stepan Company, Northbrook, IL (US)

(72) Inventors: James A. Faunce, North Aurora, IL (US); Dennis S. Murphy, Libertyville, IL (US); Ronald A. Masters, Wheeling, IL (US); Lei Cui, Bolingbrook, IL (US); Paul W. Knox, Trevor, WI (US)

(21) Appl. No.: 18/920,310

(22) Filed: Oct. 18, 2024

Related U.S. Application Data
(63) Continuation of application No. PCT/US23/18951, filed on Apr. 18, 2023.
(60) Provisional application No. 63/454,816, filed on Mar. 27, 2023.
(60) Provisional application No. 63/332,947, filed on Apr. 20, 2022.

(51) Int. Cl. C09K 23/02

(52) U.S. Cl. CPC C09K 23/02

(57) ABSTRACT

A method of mitigating the formation of 1,4-dioxane and precursors of 1,4-dioxane in alkyl ether sulfate surfactants is disclosed. The method involves adding one or more alcohol, hydrotrope or anti-oxidant additives to an aqueous solution of alkyl ether sulfate surfactant having at least two ethylene oxide groups. The alcohol, hydrotrope, or anti-oxidant is added to the alkyl ether sulfate solution in an amount effective to reduce the formation of diethylene glycol monosulfate, a precursor of 1,4-dioxane, and also reduce the formation of 1,4-dioxane.

### FIELD OF THE INVENTION

The present technology relates generally to a method of producing sulfated surfactants, such as alkyl ether sulfate surfactants, that are reduced in 1,4-dioxane impurities. More particularly, the present technology relates to methods for mitigating or suppressing the formation of 1,4-dioxane and precursors of 1,4-dioxane in alkyl ether sulfate surfactant solutions.

### BACKGROUND OF THE INVENTION

Fatty alcohol ethoxylates and fatty alcohol ethoxylate sulfates have long been used as surfactants in a wide variety of end uses. Fatty alcohol ethoxylates are typically prepared by reacting a fatty alcohol with ethylene oxide in the presence of a catalyst. In addition to the desired fatty alcohol ethoxylate end product, the reaction can also produce byproducts, such as ethylene glycol oligomers, that can impact the quality of the fatty alcohol ethoxylates.

Fatty alcohol ethoxylates are also used as a reactant to prepare alcohol ethoxylated sulfate (AES) surfactants. One known process for preparing ethoxylated fatty alcohol sulfate products is to react fatty alcohol ethoxylates with sulfur trioxide in a falling film reactor, followed by neutralization with a neutralizing agent, such as sodium hydroxide. Neutralization yields the corresponding fatty alcohol ethoxylate sulfate salt.

It is known that during the sulfation reaction, 1,4-dioxane forms as an impurity in the fatty alcohol ethoxylate sulfates. Governmental agencies have classified 1,4-dioxane as a carcinogen, and have adopted regulations to minimize its presence in consumer products. Many consumer products contain surfactants that can bring in 1,4-dioxane as a by-product of the process for manufacturing the surfactant, including alcohol ethoxylated sulfate surfactants. As a result, there have been many efforts to reduce or eliminate 1,4-dioxane impurities in AES surfactants.

It is also known that during the sulfation reaction, glycol oligomers present in the fatty alcohol ethoxylates can react with the sulfur trioxide, resulting in sulfated glycol byproducts, such as diethylene glycol monosulfate and diethylene glycol disulfate. Diethylene glycol monosulfate (DEG-MS) can break down to form 1,4-dioxane, as shown in the following reaction scheme:

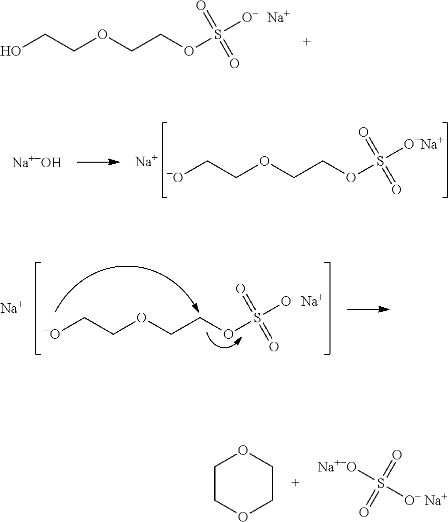

There is a need for additional methods for mitigating or suppressing the formation of 1,4-dioxane or precursors thereof, such as diethylene glycol monosulfate, in alcohol ethoxylate sulfate surfactants.

### BRIEF SUMMARY OF THE INVENTION

The present technology generally relates to a method of mitigating or suppressing the formation of 1,4-dioxane and diethylene glycol monosulfate (DEG-MS) in alkyl ether sulfate surfactant solutions. The method is based on the discovery that 1,4-dioxane and DEG-MS can form from substantially pure alkyl ether sulfate over time, which can lead to an increase of 1,4-dioxane in the surfactant due to the conversion of the DEG-MS into 1,4-dioxane.

One aspect of the present technology is a method for suppressing the formation of 1,4-dioxane and DEG-MS in alkyl ether sulfate surfactant solutions comprising the steps of providing an alkyl ether sulfate surfactant comprising two or more ethylene oxide units; and mixing one or more additives selected from the group consisting of alcohols, hydrotropes, and anti-oxidants with the alkyl ether sulfate surfactant solution in an amount effective to reduce the formation of 4-dioxane and DEG-MS in the alkyl ether sulfate solution compared to the same AES surfactant solution without the addition of the additive.

Another aspect of the present technology is an alkyl ether sulfate composition comprising from 50 wt % to 85 wt % of alkyl ether sulfate actives, wherein the alkyl ether sulfate comprises two or more ethylene oxide units; one or more additives selected from the group consisting of alcohols, hydrotropes, and anti-oxidants, wherein the one or more additives are in an amount effective to reduce formation of 1,4-dioxane and diethylene glycol monosulfate in the alkyl ether sulfate composition compared to the same alkyl ether sulfate composition without the additive; and water to total 100% of the composition.

### BRIEF DESCRIPTION OF THE DRAWINGS

[Not applicable]

### DETAILED DESCRIPTION OF THE INVENTION

While the presently described technology will be described in connection with one or more preferred embodiments, it will be understood by those skilled in the art that the technology is not limited to only those particular embodiments. To the contrary, the presently described technology includes all alternatives, modifications, and equivalents that can be included within the spirit and scope of the appended claims.

Research efforts have demonstrated that 1,4-dioxane levels in AES surfactant solutions can increase over time, particularly at elevated temperatures and at higher pH, such as 11 or above. Thus, one proposed solution has been to lower the pH range of AES surfactant solutions to a more neutral range to slow the rate of 1,4-dioxane formation. However, through research efforts it has been discovered that, although a neutral pH can lower the rate of 1,4-dioxane formation, a neutral pH for the AES surfactant solution can present additional problems. In particular, the inventors have determined that, at a pH in the neutral range, the amount of glycol, particularly diethylene glycol monosulfate (DEG-MS), can increase over time in aqueous solutions of AES surfactants having at least two ethylene oxide units. The following Table 1 shows the results from an aging study at 50° C. of samples of 3-mole ethylene oxide alkyl ether sulfate surfactant (STEOL® OS-370 PLUS, 70% actives) at both neutral and caustic pH:

TABLE 1

| | T = 0 | | 2 Weeks | | 4 Weeks | |
|---|---|---|---|---|---|---|
| | ppm | ppm | ppm | ppm | ppm | ppm |
| Material | 1,4-D | DEG-MS | 1,4-D | DEG-MS | 1,4-D | DEG-MS |
| OS-370 w/ | 4.4 | 22 | 7.5 | 35 | 7.6 | 42 |
| bicarb | | | | | | |
| buffer | | | | | | |
| adjusted to | | | | | | |
| caustic pH | | | | | | |
| with free | | | | | | |
| caustic | | | | | | |
| OS-370 w/ | 2.8 | 124 | 3.5 | 237 | 4.7 | 226 |
| bicarb | | | | | | |
| buffer- | | | | | | |
| neutral pH | | | | | | |
| OS-370 | 7.3 | 19 | 11 | 27 | 12 | 31 |
| with free | | | | | | |
| caustic- | | | | | | |
| caustic pH | | | | | | |

The results of the aging study show that DEG-MS forms more rapidly in AES solutions at neutral pH than at caustic pH over time. The results also show that DEG-MS forms directly from the AES surfactant. Since it is known that DEG-MS is a precursor of 1,4-dioxane, the increased formation of DEG-MS at neutral pH can lead to regrowth of 1,4-dioxane in AES surfactant solutions at neutral pH. Regrowth of 1,4-dioxane can be of particular concern for formulators who use AES surfactants in higher caustic formulations. As the formation of DEG-MS increases at neutral pH, more DEG-MS is available to break down into 1,4-dioxane. When the AES surfactant is then added to a caustic formulation, the higher pH can more rapidly convert the now increased DEG-MS into 1,4-dioxane, leading to an increase in 1,4-dioxane in the finished product.

Excess glycols that are by-products of the manufacture of fatty alcohol ethoxylates can be removed by an extraction process prior to sulfating the fatty alcohol ethoxylates, thereby limiting the amount of DEG-MS that could be formed during the sulfation process. A reduced amount of DEG-MS can lead to less regrowth of 1,4-dioxane in the AES surfactant solution. However, as shown in Table 1, since DEG-MS can form directly from the AES surfactant solution over time, processing efforts, such as extraction procedures, which reduce or eliminate free glycols prior to sulfation may help, but do not completely mitigate the presence of 1,4-dioxane and DEG-MS in AES surfactant solutions.

The mechanism for the formation of DEG-MS from aqueous solutions of AES surfactants having more than one ethylene oxide unit is not entirely clear. Without being bound by theory, one possible mechanism is that DEG-MS may be formed through a peroxide intermediate as shown in the following reaction scheme:

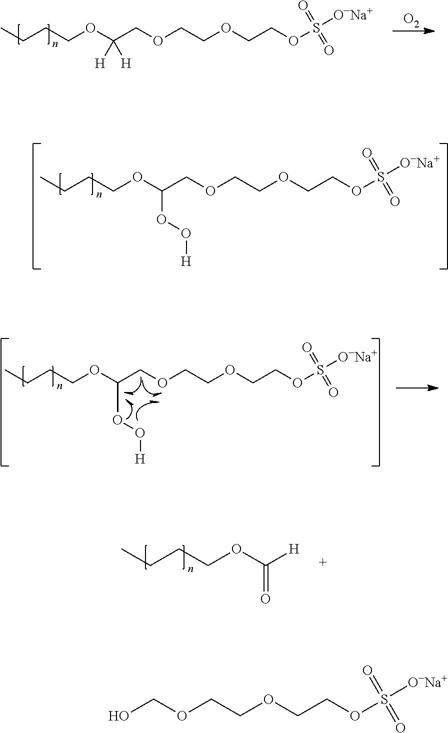

Another possible mechanism is that DEG-MS forms through free-radical processes implicated in autoxidation. Copious autoxidation reaction pathways are autocatalytic chain reactions that result in complex cascades of uncounted oxidation products of organic compounds such as ethoxylates. Essential to autoxidation is molecular oxygen addition, typically to either a carbon-carbon multiple bond, or to a radical formed by hydrogen atom abstraction from a carbon-hydrogen bond. Molecular oxygen addition to either species is rapid and transiently forms a peroxyl radical. Peroxyl radicals rapidly combine with another peroxyl radical to form a short-lived tetra-oxygen intermediate. Tetra-oxygen species beget various chain reaction pathways through spontaneous fragmentation into an oxygen molecule and two alkoxyl radicals. Alkoxyl radical species from ethoxylates are subsequently transformed to an expansive variety of non-radical compounds. In AES surfactant solutions, many of these compounds generate DEG-MS through hydrolysis or further autoxidation. The reaction schemes below illustrate two hypothesized routes that generate DEG-MS through hydrolysis of water-sensitive hemiacetals and esters produced via autoxidation:

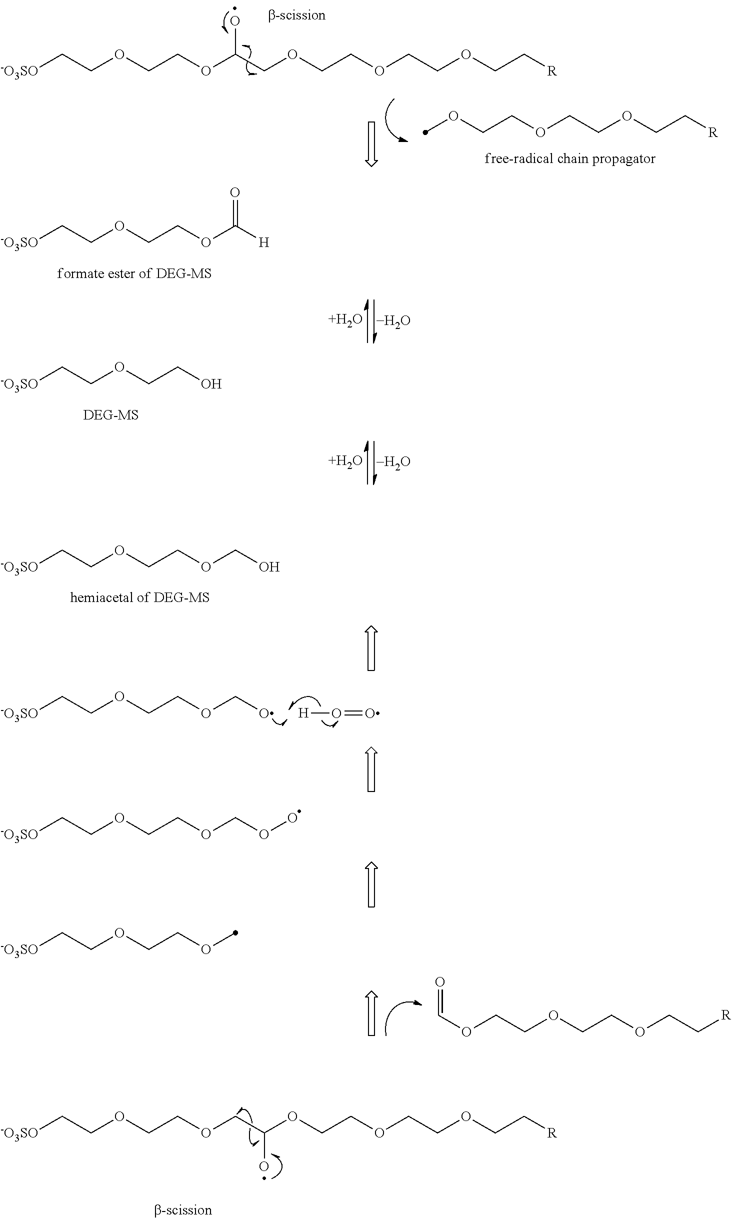

The present technology is directed to the discovery that adding one or more additives selected from the group consisting of alcohols, hydrotropes, and anti-oxidants to an AES surfactant solution can slow the formation of DEG-MS and 1,4-dioxane in the AES surfactant solution. The AES surfactant solution may be a concentrate and may comprise from 50 wt % to 85 wt % of AES surfactant and water. Alternatively, the AES surfactant solution may comprise from 1 wt % to about 25 wt % AES surfactant and water. In one embodiment, an alcohol is added to the aqueous solution of AES surfactant in an amount effective to reduce the formation of DEG-MS in the AES surfactant compared to the same AES surfactant solution without the addition of the alcohol. Generally, any alcohol having a molecular weight below about 200 would be expected to be of benefit as an additive. Alcohols that have been found useful as an additive for mitigating DEG-MS formation include ethanol, isopropyl alcohol (IPA), t-butyl alcohol, and propylene glycol. Other alcohols that may also be used as an additive include, but are not limited to, methanol, 1-propanol, 1-butanol, 1,3-butanediol, and hexylene glycol (2-methyl-2,4-pentanediol). An effective amount of alcohol may be in the range of about 1 wt % to about 12 wt %, alternatively about 2 wt % to about 10 wt %, alternatively about 3 wt % to about 10 wt % based on the weight of the AES surfactant solution. Some alcohol additives are volatile organic compounds (VOCs), which are undesirable from an environmental standpoint. Thus, it is advantageous to utilize an amount of alcohol additive that is effective to mitigate DEG-MS formation, yet also minimize, to the extent possible, the amount of VOCs released into the environment.

Without being bound by theory, it is thought that an alcohol, particularly an alcohol having a molecular weight of less than about 200, when added to the AES surfactant solution can get between the head groups in the palisade layer of the surfactant micelles, thereby physically blocking/inhibiting molecular oxygen from forming a peroxide intermediate. Without the alcohol additive, molecular oxygen may react with the AES surfactant to form a peroxide intermediate, which may form the DEG-MS. The rate of DEG-MS formation is higher in AES surfactant solutions at neutral pH compared to AES surfactant solutions at a higher caustic pH. The reason for this may be due to peroxide destabilizing at high (e.g. about 11 or higher) pH, resulting in less peroxide available to form the DEG-MS in higher pH AES solutions. Thus, an alcohol additive is particularly useful for mitigating or suppressing the formation of DEG-MS in AES surfactant solutions that are at a neutral pH.

The alcohol can be mixed with the AES surfactant solution using any suitable mixing equipment. In some embodiments, the alcohol additive and AES surfactant can be mixed simply by shaking the components together in a container. The mixing can be done at ambient temperature.

In another embodiment, the additive is a hydrotrope that is mixed with the AES surfactant solution to slow the formation of DEG-MS. One hydrotrope that has been found useful for mitigating DEG-MS in AES solutions having a caustic pH is sodium xylene sulfonate (SXS). The addition of SXS to AES solutions having a pH of 9 or greater can reduce the formation of DEG-MS by at least 85% after 4 weeks. Addition of SXS to neutral (pH 6-8) AES solutions does not result in a similar reduction of DEG-MS formation. Other hydrotropes that may be used as an additive to mitigate DEG-MS formation include sodium cumene sulfonate (SCS) and sodium toluene sulfonate (STS). The hydrotrope is added to the AES surfactant solution in an amount effective to reduce the formation of DEG-MS in the AES solution compared to the same AES surfactant solution without the addition of hydrotrope additive. An effective amount of a hydrotrope may be in the range of about 0.1 wt % to about 5 wt %, alternatively 0.25 wt % to about 4 wt %, alternatively about 0.5 wt % to about 3 wt % based on the weight of the AES surfactant solution. The hydrotrope can be mixed with the AES surfactant solution using any suitable mixing equipment.

It is thought that the hydrotrope additive, such as SXS, functions in a manner similar to the alcohol additive, by physically blocking/inhibiting peroxide formation in the palisades layer of the micelles thereby slowing down the formation of DEG-MS. Without the hydrotrope addition, molecular oxygen may react with the AES surfactant to form a peroxide intermediate, which may form the DEG-MS.

In another embodiment, the additive is an anti-oxidant that is mixed with the AES surfactant solution. Anti-oxidants that can be used for mitigating the formation of DEG-MS include, but are not limited to, tert butylhydroquinone (TBHQ), butylated hydroxyanisole (BHA), butylated hydroxytoluene (BHT), citrate, where at least two, and preferably all three, of the carboxylate groups are ionized, and Vitamins A, C, D, and E. The anti-oxidant additive is added to the AES surfactant solution in an amount effective to reduce the formation of DEG-MS in the AES solution compared to the same AES surfactant solution without the anti-oxidant additive. An effective amount of the anti-oxidant is in the range of about 0.1 wt % to about 3.0 wt % based on the weight of the AES surfactant solution.

The presently described technology and its advantages will be better understood by reference to the following examples. These examples are provided to describe specific embodiments of the present technology. By providing these specific examples, it is not intended to limit the scope and spirit of the present technology. It will be understood by those skilled in the art that the full scope of the presently described technology encompasses the subject matter defined by the claims appended to this specification, and any alterations, modifications, or equivalents of those claims.

In the following examples, concentrations of 1,4-dioxane in the various surfactant matrices are determined by headspace gas chromatographic mass spectrometry (HS-GCMS) run in selective ion mode (SIM), looking specifically at ions 58 and 87 m/z for 1,4-dioxane, and 58 and 88 m/z for 1,3-dioxane. These ions, at a specific ratio, are unique to 1,3- and 1,4-dioxane. For the purposes of monitoring stability, the concentration of 1,4-dioxane is determined using a 3-point calibration curve made for each sample. The calibration curve is constructed with the amount of 1,4-dioxane in parts per million (amount ratio) vs. a response measured as an area ratio.

In the following examples, concentrations of DEG-MS are determined by using ultra-performance liquid chromatography coupled to mass spectrometry (UPLC-MS). Extracted ion chromatograms using m/z 185.0125 (±0.01 Da) corresponding to the negative ion of DEG-MS were integrated for peak response. For quantitation, sample peak responses were correlated to an external calibration curve constructed of DEG-MS standards prepared in various known concentrations.

### Examples

### Example 1: Preparation of Pure Alkyl Ether

Triethylene glycol (Alfa-Aesar, 99%, 750 g, 4.99 Mol) was charged to a 2 L reaction vessel equipped with mechanical stirring, a thermocouple/nitrogen inlet adaptor and a short-path distillation sidearm attached to a nitrogen/vacuum line. The glycol was stirred under nitrogen and heated to 70° C. Aqueous NaOH (50%, 80 g, 1 Mol NaOH) was charged to an addition funnel and added dropwise to the stirred glycol over the course of 30 minutes, resulting in a moderate exotherm and the development of a red/brown color. The mixture was stirred for 30 minutes and then the pressure slowly reduced with a clean receiver cooled in dry ice in order to strip H₂O. When stripping was complete, the apparatus was backfilled with nitrogen, the temperature reduced to 60° C. and the condensate (62 g) discarded. Bromododecane (Alfa-Aesar, 99%, 250 g, 1 Mol) was charged to an addition funnel and added dropwise to the stirred mixture over 2.5 hours. When the addition was complete, the mixture was stirred for 1 hour at 70° C. and then overnight with cooling to room temperature. Heating to 100° C. was then initiated, and when the mixture had reached 75° C., the pressure was gradually decreased with a clean 100 mL receiver in dry ice in order strip volatiles. Distillation began at 100° C. and <2 mm Hg, and as the rate slowed the temperature was increased in increments to 135° C. When the head temperature reached 120° C., the vessel was backfilled with nitrogen and the receiver exchanged for a clean 1 L vessel in order to collect excess triethylene glycol distillate. The glycol was distilled at 140-145° C. and a head temperature of 120-125° C. at <0.2 mm Hg until distillation ceased. Heating was then discontinued, and the vessel backfilled with nitrogen and allowed to cool. When the mixture had cooled to 60° C., approximately 400 mL deionized water was added with good agitation and a pH probe was inserted into the mixture. 50% H₂SO₄ was added dropwise until a stable pH of 7.5 was reached and the mixture was transferred to a 1 L separatory funnel. Approximately 250 mL hexanes were added and the mixture shaken well, giving a milky red/brown emulsion. Isopropanol was added in small portions, followed by thorough mixing until clean phase separation was observed. After settling, the light red/brown aqueous layer was drained off and retained and the dark organic layer was drained into a 1 L flask and the volatiles removed via rotary evaporator, affording approximately 300 mL of a red/brown liquid. The aqueous layer was returned to the separatory funnel and extracted with hexanes (1×300 mL) and the organic layer combined with the crude product mixture and the volatiles again removed via rotary evaporator. Approximately half of the glycol distillate (net, 624 g) was transferred to the 1 L separatory funnel and diluted with an equal volume of deionized water plus approximately 25 mL of 20% aqueous NaCl. Approximately 200 mL hexanes were added, the mixture shaken well to mix and then allowed to settle. Addition of approximately 10 mL isopropanol gave rapid and clean phase separation and the aqueous layer was drained off and discarded. The organic layer was combined with the previously obtained crude product mixture and the volatiles removed via rotary evaporation. The remainder of the glycol distillate was extracted as described above, and the organic layer combined with the previous material and the volatiles again removed via rotary evaporation. In this manner, an additional 24.1 g of product was recovered from the excess glycol distillate. The crude product mixture was transferred to a 500 mL 3-necked round bottom flask equipped with mechanical stirring, a thermocouple/nitrogen inlet adaptor and a short-path distillation sidearm for vacuum stripping and distillation. A 50 mL receiver was cooled in dry ice, the mixture stirred and heated to 100° C. and the pressure gradually reduced to full vacuum. When stripping appeared to be complete, the temperature was increased in increments to 180° C., resulting in slow distillation of the target product. When the head temperature reached 140° C., the vessel was backfilled with nitrogen and a clean 500 mL receiver attached to the overhead to collect the product fraction. The product fraction was collected at a pot temperature of 185-200° C. (head temperature 170-175° C., <2 mm Hg) until distillation ceased. Heating was discontinued and the vessel backfilled with nitrogen and allowed to cool. The product fraction and distillation bottoms (˜50 mL, dark liquid with fine solids) were analyzed by gas chromatography. The product fraction (212 g, 66.6% yield) was found to be 99.2% triethylene glycol dodecyl ether with a trace amount of the didodecyl ether, and the distillation bottoms were found to contain 22.5% triethylene glycol monododecyl ether and 75.2% didodecyl ether. The triethylene glycol dodecyl ether product was transferred to a glass bottle for storage.

### Example 2: Preparation of Pure Alkyl Ether Sulfate

Pyridine-SO₃ complex (Aldrich, 52 g, 0.326 Mol) was charged to a 1 L reaction vessel equipped with mechanical stirring, a thermocouple/nitrogen inlet adaptor and a reflux condenser attached to a nitrogen overhead and slurried in approximately 600 mL CHCl₃ under nitrogen. The mixture was stirred and warmed to 50° C., and triethylene glycol monododecyl ether as prepared in Example 1 (99.2% pure, 100 g, 0.314 Mol) was added dropwise via addition funnel over approximately 3 hours. The resulting clear, light-brown reaction mixture was stirred for one hour at 50° C. and then overnight with cooling to room temperature. The mixture was filtered, and the clear, light-brown filtrate was evaporated to dryness via rotary evaporator, affording a pasty semisolid. The material was taken up in approximately 300 mL methanol and the mixture returned to the 1 L reaction vessel and stirred mechanically with a pH probe inserted into the solution. Aqueous NaOH (50 wt. %, 26.2 g) was added in portions via pipette until a stable pH of 7.7 was reached. After cooling, the hazy mixture was filtered through a pad of diatomaceous earth in order to remove a gelatinous precipitate. The filter pad was washed thoroughly with methanol and the light-yellow filtrate evaporated to dryness via rotary evaporator, affording a pasty semisolid. Approximately 700 mL acetone was added to the vessel and thorough mixing gave a small quantity of a waxy white precipitate and a yellow solution. After standing at room temperature for several days, a large mass of white solid had formed. The mass was broken up with a spatula and the solid isolated by filtration on a large Büchner funnel and washed thoroughly with acetone. The solid was dried in air and then under high vacuum, affording the product, triethylene glycol dodecyl ether sulfate, Na salt (AE3S) (100.2 g, 75.9% yield) as a free-flowing white powder, which was transferred to a glass jar for storage. Analysis of the product by NMR was consistent with its expected structure and indicated a high degree of purity, and analysis by potentiometric titration (Hyamine) indicated it to contain 97.7% anionic active material.

### Example 3: Stability of DEG-MS at Caustic pH

An aqueous solution of DEG-MS at 1% concentration was prepared to assess the formation of 1,4-dioxane from DEG-MS over time. The DEG-MS solution was adjusted to a caustic pH (pH 10-11) with a 50% solution of NaOH. Samples of the DEG-MS solution were analyzed for initial 1,4-dioxane content, and 1,4-dioxane content after 2 weeks and after 4 weeks of storage at 50° C. The 1,4-dioxane amounts were determined by the analytical procedure described above. The results are shown in Table 2:

TABLE 2

| | Initial | 1,4-dioxane | 1,4-dioxane |
|---|---|---|---|
| | 1,4-dioxane | 2 Weeks | 4 Weeks |
| Sample | (ppm) | (ppm) | (ppm) |
| DEG-MS 1% solution, | 0.10 | 75.62 | 117.85 |
| caustic pH (10-11) | | | |

The results in Table 2 demonstrate that pure DEG-MS at 1% in caustic solution leads to significant 1,4-dioxane growth.

### Example 4: Stability of AE3S at Neutral pH

A 20% active AE3S aqueous solution was prepared from the AE3S anionic surfactant of Example 2 using an overhead mixer and mixing until the solid powder was mixed into solution. The initial pH of the solution was measured at 4.31. Citric acid and sodium hydroxide, 50% solution, were added to adjust the AE3S solution to a pH of 5.46. Samples of the solution were analyzed for initial DEG-MS content, and DEG-MS content after 2 weeks and after 4 weeks of storage at 50° C. The DEG-MS amounts were determined by the analytical procedure described above. The results are shown in Table 3.

TABLE 3

| | Initial | DEG-MS | DEG-MS |
|---|---|---|---|
| | DEG-MS | 2 Weeks | 4 Weeks |
| Sample | (mg/kg) | (mg/kg) | (mg/kg) |
| AE3S Solution (20% actives), | 27 | 55.9 | 85.3 |
| neutral pH (pH = 5.46) | | | |

The results in Table 3 show that, at neutral pH, the amount of DEG-MS in the AE3S surfactant (97% purity) grows over time at elevated temperatures. Since DEG-MS can form 1,4-dioxane, increasing amounts of DEG-MS in the surfactant itself can lead to increased amounts of 1,4-dioxane in the surfactant.

### Example 5: Stability of AE3S at Caustic pH

A 20% active AE3S solution was prepared from the AE3S anionic surfactant of Example 2 using an overhead mixer and mixing until the solid powder was mixed into solution. The pH of the solution was adjusted to a caustic pH (pH 10-11) with NaOH. Samples of the AE3S solution were analyzed for initial DEG-MS content, and DEG-MS content after 2 weeks and after 4 weeks of storage at 50° C. The DEG-MS amounts were determined by the analytical procedure described above. The results are shown in Table 4.

TABLE 4

| | Initial | DEG-MS | DEG-MS |
|---|---|---|---|
| | DEG-MS | 2 Weeks | 4 Weeks |
| Sample | (mg/kg) | (mg/kg) | (mg/kg) |
| AE3S Solution (20% actives), | 16.0 | 32.5 | 18.3 |
| caustic pH (pH 10-11) | | | |

The results in Table 4 show that, in a caustic solution of AE3S surfactant, DEG-MS does not form as quickly compared to DEG-MS growth in a neutral solution. (Compare Table 3 and Table 4). Although the mechanism for the formation of DEG-MS from an AE3S solution is not entirely clear, without being bound by theory, DEG-MS may be formed through a peroxide intermediate. Since peroxides are known to destabilize at higher pH, the formation of DEG-MS in a caustic solution of AE3S may be slower due to less peroxide in the solution.

### Example 6: Effect of Ethanol on DEG-MS Formation in AES Surfactant at Neutral pH

Different amounts of ethanol additive were mixed with samples of “as-is” (70% actives) bicarbonate buffered 3 mole ethylene oxide alkyl ether sulfate surfactant (OS-370). The different amounts of ethanol were 5 wt %, 10 wt %, and 15 wt % based on the weight of the AES surfactant solution. A sample containing no ethanol (0 wt %) served as a control to assess the effect of the ethanol addition on the formation of DEG-MS. The solutions were mixed by shaking the components together in a container. Each solution had a neutral pH (pH 8-9). The samples were analyzed for initial DEG-MS content, and DEG-MS content after 2 weeks and 4 weeks of storage at 50° C. The DEG-MS amounts were determined by the analytical procedure described above. The results are shown in Table 5.

TABLE 5

| | DEG-MS | DEG-MS | DEG-MS |
|---|---|---|---|
| | Initial | 2 Weeks | 4 Weeks |
| Sample | (mg/kg) | (mg/kg) | (mg/kg) |
| OS-370 + 0% ethanol | 1.9 | 113 | 150 |
| (control) | | | |
| OS-370 + 5% ethanol | 1.6 | 14.8 | 53.9 |
| OS-370 + 10% ethanol | 1.7 | 3.2 | 10.6 |
| OS-370 + 15% ethanol | 2.2 | 2.1 | 8.4 |

The results in Table 5 show that DEG-MS formation was dramatically reduced in the ethanol-containing samples compared to the control sample. These results demonstrate that adding ethanol to the AES surfactant can reduce or suppress the formation of DEG-MS in alkyl ether sulfate surfactants at neutral pH.

### Example 7: Effect of Hydrotrope on DEG-MS Formation at Caustic pH

Three 10 wt % active aqueous solutions of 3-mole ethylene oxide alkyl ether sulfate surfactant were prepared and the pH of each was adjusted to a pH of 11-12. Sodium xylene sulfonate (SXS), a hydrotrope, was added to one solution in an amount of 1 wt % and to a second solution in an amount of 0.5 wt % based on the weight of the AES surfactant solution. The third aqueous solution served as a comparative to assess the effect of added hydrotrope on the formation of DEG-MS. Samples of each solution were analyzed for initial DEG-MS content, and DEG-MS content after 2 weeks and 4 weeks of storage at 50° C. The DEG-MS amounts were determined by the analytical procedure described above. The results are shown in Table 6.

TABLE 6

| | Initial | DEG-MS | DEG-MS |
|---|---|---|---|
| | DEG-MS | 2 Weeks | 4 weeks |
| Sample | (mg/kg) | (mg/kg) | (mg/kg) |
| 10% active OS-370 | 2.3 | 13.6 | 194.8 |
| (pH 11-12) | | | |
| 10% active OS-370 + | 3.7 | 4.4 | 25.6 |
| 1% SXS (pH 11-12) | | | |
| 10% active OS-370 + | 1.3 | 51.8 | 21.6 |
| 0.5% SXS (pH 11-12) | | | |

The results show that adding 1 wt % of SXS hydrotrope to a caustic pH solution of alkyl ether sulfate surfactant can mitigate the formation of DEG-MS. The results also show that adding SXS in an amount of 0.5 wt % can reduce the formation of DEG-MS after 4 weeks.

### Example 8: Effect of Anti-Oxidant on DEG-MS Formation at Neutral pH

Three 10 wt % active aqueous solutions of 3-mole ethylene oxide alkyl ether sulfate surfactant were prepared, and the pH of each was adjusted to a pH of 8-9. Tert-butylhydroquinone (TBHQ) was added to one solution in an amount of 0.25 wt %, and butylated hydroxyanisole (BHA) was added to a second solution in an amount of 0.25 wt % based on the weight of the AES surfactant solution. The third aqueous solution served as a comparative to assess the effect of added anti-oxidant on the formation of DEG-MS at neutral pH. Samples of each solution were analyzed for initial DEG-MS content, and DEG-MS content after 2 weeks and 4 weeks of storage at 50° C. The DEG-MS amounts were determined by the analytical procedure described above. The results are shown in Table 7.

TABLE 7

| | Initial | DEG-MS | DEG-MS |
|---|---|---|---|
| | DEG-MS | 2 Weeks | 4 weeks |
| Sample | (mg/kg) | (mg/kg) | (mg/kg) |
| 10% active OS-370 | 2.9 | 15.8 | 224.5 |
| (pH 8-9) | | | |
| 10% active OS-370 + | 3.3 | 22.0 | 77.3 |
| 0.25% TBHQ (pH 8-9) | | | |
| 10% active OS-370 + | 2.2 | 38.6 | 40.1 |
| 0.25% BHA (pH 8-9) | | | |

The results show that adding TBHQ and BHA anti-oxidants to a neutral pH solution of alkyl ether sulfate surfactant can reduce or suppress the formation of DEG-MS after 4 weeks.

### Example 9: Effect of Anti-Oxidant on DEG-MS at Caustic pH

Three 10 wt % active aqueous solutions of 3-mole ethylene oxide alkyl ether sulfate surfactant were prepared, and the pH of each was adjusted to a caustic pH of 11-12. Tert-butylhydroquinone (TBHQ) was added to one solution in an amount of 0.25 wt %, and butylated hydroxyanisole (BHA) was added to a second solution in an amount of 0.25 wt % based on the weight of the AES surfactant solution. The third aqueous solution served as a comparative to assess the effect of added anti-oxidant on the formation of DEG-MS at caustic pH. Samples of each solution were analyzed for initial DEG-MS content, and DEG-MS content after 2 weeks and 4 weeks of storage at 50° C. The DEG-MS amounts were determined by the analytical procedure described above. The results are shown in Table 8.

TABLE 8

| | Initial | DEG-MS | DEG-MS |
|---|---|---|---|
| | DEG-MS | 2 Weeks | 4 weeks |
| Sample | (mg/kg) | (mg/kg) | (mg/kg) |
| 10% active OS-370 | 2.9 | 15.8 | 224.5 |
| (pH 11-12) | | | |
| 10% active OS-370 + | 1.9 | 26.3 | 41.0 |
| 0.25% TBHQ (pH 11-12) | | | |
| 10% active OS-370 + | 2.6 | 20.3 | 44.9 |
| 0.25% BHA (pH 11-12) | | | |

The results show that adding TBHQ and BHA anti-oxidants to a caustic pH solution of alkyl ether sulfate surfactant can reduce or suppress the formation of DEG-MS after 4 weeks.

### Example 10: Effect of Additives on DEG-MS Formation in AES Surfactant

Different additives were mixed with samples of “as is” (70% active) 3-mole ethylene oxide alkyl ether sulfate (OS-370) to assess the effect of the additives on DEG-MS and 1,4-dioxane formation in the AES surfactant. The OS-370 surfactant with added additives also included a bicarbonate buffer treated with CO2. A sample containing just the bicarbonate buffered OS-370 served as a control. The different additives added to the samples were ethyl alcohol, isopropyl alcohol (IPA), tert-butyl alcohol, propylene glycol, peroxide, and a mixture of ethanol and BHA. Additional samples were also prepared, with one sample containing the OS-370 surfactant and free NaOH, but no bicarbonate buffer, to provide a higher caustic pH, and another sample containing the OS-370 surfactant and free NaOH, but 1 wt % of a citric acid/phosphoric acid buffer, instead of bicarbonate buffer. The citric acid/phosphate buffer comprised 50 wt % citric acid and 5 wt % phosphoric acid. Details of the samples tested and the amounts of additives added are shown in Table 9 below. The samples were analyzed for initial 1,4-dioxane and DEG-MS content, and analyzed for 1,4-dioxane and DEG-MS content after 2 weeks of storage at 50° C. The results are shown in Table 9.

TABLE 9

| | 1,4-Dioxane | | DEG-MS | | |
|---|---|---|---|---|---|
| | Initial | 1,4-Dioxane | Initial | DEG-MS | |
| | 1,4-dioxane | 2 Weeks | DEG-MS | 2 weeks | Initial |
| Sample | (mg/kg) | (mg/kg) | (mg/kg) | (mg/kg) | pH |
| OS-370 (no | 2.18 | 3.03 | 38.1 | 209.4 | 9.02 |
| additive) | | | | | |
| OS-370 + | 2.02 | 2.85 | 26.7 | 19.6 | 7.78 |
| 5 wt % IPA | | | | | |
| OS-370 + | 1.93 | 2.73 | 24.1 | 75.6 | 7.87 |
| 5 wt % t-butyl | | | | | |
| OS-370 + | 2.11 | 2.92 | 25.7 | 33.4 | 7.72 |
| 5 wt % glycol | | | | | |
| OS-370 + | 1.79 | 2.95 | 154.2 | 152.5 | 7.36 |
| 0.1 wt % peroxide | | | | | |
| AES + 1 wt % | 1.97 | 2.88 | 27.3 | 21.0 | 7.66 |
| Cit/phos buffer + | | | | | |
| NaOH | | | | | |
| AES + NaOH | 2.53 | 3.49 | 31.2 | 25.7 | 11.61 |
| (no buffer) | | | | | |
| OS-370 + | 1.99 | 2.46 | 52.2 | 167.9 | 9.04 |
| 0.5 wt % EtOH | | | | | |
| OS-370 + | 1.87 | 2.99 | 36.8 | 146.1 | 9.07 |
| 1 wt % EtOH | | | | | |
| OS-370 + | 1.88 | 2.54 | 31.3 | 51.8 | 9.15 |
| 3 wt % EtOH | | | | | |
| OS-370 + | 1.73 | 1.87 | 28.8 | 23.2 | 9.10 |
| 5 wt % EtOH | | | | | |
| OS-370 + | 2.20 | 2.78 | 62.9 | 116.6 | 9.04 |
| 0.5 wt % BHA + | | | | | |
| 0.5 wt % EtOH | | | | | |

A number of findings are evident from the results in Table 9. The results show a substantial increase in the formation of DEG-MS after two weeks, compared to the initial amount of DEG-MS in the sample of bicarbonate buffered OS-370 surfactant with no additive. Adding the alcohol additives to the bicarbonate buffered OS-370 surfactant reduced or suppressed the formation of DEG-MS in the samples after 2 weeks compared to the control. Surprisingly, the addition of 5% ethanol also minimized the formation of 1,4-dioxane as well. The combination of BHA anti-oxidant and ethanol as an additive also suppressed the formation of DEG-MS after 2 weeks compared to the control. Adding peroxide to the bicarbonate buffered OS-370 resulted in the formation of a substantial amount of DEG-MS in the initial sample, but no increase after 2 weeks of storage. The results from the peroxide addition provide support for the theory that the formation of a peroxide intermediate may lead to the formation of DEG-MS. Using a citric acid/phosphoric acid buffer reduced or suppressed the formation of DEG-MS after 2 weeks compared to the control.

The results in Table 9 show that the addition of alcohol and anti-oxidant additives mitigate the formation of DEG-MS and, in some cases, mitigate the formation of 1,4-dioxane in AES surfactants. Since DEG-MS can break down into 1,4-dioxane, mitigating the formation of DEG-MS, as well as 1,4-dioxane, can minimize 1,4-dioxane regrowth in AES surfactants.

### Example 11: Effect of Ethanol on 1,4-Dioxane Formation in Pure AES-2 Surfactant

A 20% active alkyl ether sulfate (2 moles ethylene oxide) (AES2) aqueous solution was prepared from a pure AES2 anionic surfactant. The AES2 surfactant was prepared in a manner similar to Example 2. Samples of the AES2 aqueous solution were prepared, and an additive of 5 wt % ethanol was added to one sample. A second sample, with no additive, served as a control. The sample solutions were analyzed for initial 1,4-dioxane content, and then for 1,4-dioxane content after 2 weeks and after 4 weeks of storage at 50° C. The 1,4-dioxane amounts were determined by the analytical procedure described above. The results are shown in Table 10.

TABLE 10

| | Initial | 1,4-Dioxane | 1,4-Dioxane |
|---|---|---|---|
| | 1,4-Dioxane | 2 Weeks | 4 Weeks |
| Sample | (mg/kg) | (mg/kg) | (mg/kg) |
| AES-2 Solution | <LoQ | 0.39 | 0.84 |
| (20% actives), | | | |
| neutral pH | | | |
| (pH = 6.24) | | | |
| AES-2 Solution | <LoQ | 0.30 | 0.61 |
| (20% actives), | | | |
| neutral pH | | | |
| (pH = 6.21) + | | | |
| 5 wt % EtOH | | | |

The results in Table 10 show that, at neutral pH, the amount of 1,4-dioxane in the AES2 surfactant (97% purity) grows over time at elevated temperatures. The results also show that adding 5 wt % ethanol can mitigate the formation of 1,4-dioxane in AES surfactants.

### Example 12: Effect of Additives on 1,4-Dioxane Formation in AES Surfactants

Different additives were added to samples of different concentrations of “as is” (70 wt % active) 3-mole ethylene oxide alkyl ether sulfate (OS-370) to assess the effect of the additives on 1,4-dioxane formation in the AES surfactant. Ethanol additive in an amount of 5 wt % was added to a sample of 70 wt % active OS-370, and BHT additive in an amount of 0.25 wt % was added to a sample of OS-370 diluted to 10 wt % actives. Samples without the additives served as controls. The sample solutions were analyzed for initial 1,4-dioxane content, and the 1,4-dioxane content after 2 weeks, 4 weeks, and 8 weeks of storage at 50° C. The 1,4-dioxane amounts were determined by the analytical procedure described above. The results are shown in Table 11.

TABLE 11

| | Initial | 2 Weeks | 4 weeks | 8 weeks |
|---|---|---|---|---|
| | 1,4-dioxane | 1,4-dioxane | 1,4-dioxane | 1,4-dioxane |
| Sample | (mg/kg) | (mg/kg) | (mg/kg) | (mg/kg) |
| OS-370 (70% | 6.69 | 6.84 | 7.34 | 10.23 |
| actives) | | | | |
| OS-370 (70% | 6.03 | 5.96 | 6.49 | 8.12 |
| actives) + | | | | |
| 5 wt % | | | | |
| EtOH | | | | |
| OS-370 (10% | 1.01 | 1.04 | 1.09 | 1.46 |
| actives) | | | | |
| OS-370 (10% | 0.78 | 0.73 | 0.87 | 1.23 |
| Actives) + | | | | |
| 0.25 wt % | | | | |
| BHT | | | | |

The results in Table 11 show that adding ethanol or BHT to AES surfactants can mitigate the formation of 1,4-dioxane in the surfactants.

### Example 13: Effect of Additives on 1,4-Dioxane Formation in AES Surfactants

BHT additive in an amount of 0.25 wt % was added to each of a sample of 10 wt % active OS-370 and a sample of 10 wt % active 2-mole ethylene oxide alkyl ether sulfate (OS-270) to assess the effect of BHT additive on 1,4-dioxane formation in the AES surfactants. Samples without the additives served as controls. The sample solutions were analyzed for initial 1,4-dioxane content, and 1,4-dioxane content after 2 weeks, 4 weeks, and 9 weeks of storage at 50° C. The 1,4-dioxane amounts were determined by the analytical procedure described above. The results are shown in Table 12.

TABLE 12

| | Initial | 2 Weeks | 4 weeks | 9 weeks |
|---|---|---|---|---|
| | 1,4-dioxane | 1,4-dioxane | 1,4-dioxane | 1,4-dioxane |
| Sample | (mg/kg) | (mg/kg) | (mg/kg) | (mg/kg) |
| OS-370 (10% | 0.50 | 0.69 | 0.74 | 1.00 |
| actives) | | | | |
| OS-370 (10% | 0.38 | 0.47 | 0.61 | 0.88 |
| actives) + | | | | |
| 0.25% BHT | | | | |
| OS-270 (10% | 1.46 | 1.56 | 1.68 | 2.14 |
| actives) | | | | |
| OS-270 (10% | 0.86 | 1.05 | 1.16 | 1.57 |
| Actives) + | | | | |
| 0.25% BHT | | | | |

The results in Table 12 show that adding BHT to AES surfactants can mitigate the formation of 1,4-dioxane in the surfactants.

As used herein, “about” means +/−10% of the referenced value. In certain embodiments, about means +/−5% of the referenced value, or +/−4% of the referenced value, or +/−3% of the referenced value, or +/−3% of the referenced value, or +/−2% of the referenced value, or +/−1% of the referenced value.

The present technology is now described in such full, clear and concise terms as to enable a person skilled in the art to which it pertains, to practice the same. It is to be understood that the foregoing describes preferred embodiments of the present technology and that modifications may be made therein without departing from the spirit or scope of the present technology as set forth in the appended claims. Further, the examples are provided to not be exhaustive but illustrative of several embodiments that fall within the scope of the claims.

What is claimed is:

1. A method of mitigating the formation of diethylene glycol monosulfate (DEG-MS) in a surfactant comprising the steps of:
(a) providing an alkyl ether sulfate surfactant having two or more ethylene oxide units, wherein the alkyl ether sulfate surfactant is a concentrate comprising from 50 wt % to 85 wt % of alkyl ether sulfate actives and water;
(b) adding one or more additives selected from the group consisting of alcohols, hydrotropes, and anti-oxidants to the alkyl ether sulfate actives, in an amount effective to reduce the formation of DEG-MS in the alkyl ether sulfate actives compared to the same alkyl ether sulfate actives but without the addition of additive.

2. The method of claim 1, wherein the effective amount of alcohol additive is in the range of 1 wt % to 12 wt %, preferably greater than 1 wt % to 10 wt % and wherein the alcohol additive has a molecular weight of less than 200.

3. The method of claim 2, wherein the alcohol additive is one or more of ethanol, isopropyl alcohol, tert-butyl alcohol, propylene glycol, methanol, 1-propanol, 1-butanol, 1,3-butanediol, or hexylene glycol (2-methyl-2,4-pentanediol).

4. The method of claim 1, wherein the effective amount of hydrotrope is in the range of 0.1 wt % to 5 wt % and wherein the hydrotrope is one or more of sodium xylene sulfonate, sodium cumene sulfonate, or sodium toluene sulfonate.

5. The method of claim 1, wherein the anti-oxidant additive is in the range of 0.1 wt % to 3.0 wt % and wherein the anti-oxidant additive is one or more of tert butylhydroquinone (TBHQ), butylated hydroxyanisole (BHA), butylated hydroxytoluene (BHT), citrate, Vitamin A, Vitamin C, Vitamin D, or Vitamin E.

6. The method of claim 1, wherein the alkyl ether sulfate surfactant has a neutral pH.

7. The method of claim 1, wherein the alkyl ether sulfate surfactant has a caustic pH.

8. The method of claim 1, wherein the additive also reduces the formation of 1,4-dioxane in the alkyl ether sulfate actives.

9. The method of claim 1, wherein the method further comprises diluting the alkyl ether sulfate surfactant in water to form a diluted aqueous solution, wherein the diluted aqueous solution comprises 1 wt % to 25 wt % of the alkyl ether sulfate actives.

10. An alkyl ether sulfate composition comprising:
(a) from 50 wt % to 85 wt % of alkyl ether sulfate actives, wherein the alkyl ether sulfate comprises two or more ethylene oxide units;
(b) one or more additives selected from the group consisting of alcohols, hydrotropes, and anti-oxidants, wherein the one or more additives are in an amount effective to reduce formation of diethylene glycol monosulfate in the alkyl ether sulfate composition compared to the same alkyl ether sulfate composition without the additive; and
(c) water to total 100% of the composition.

11. The composition of claim 10, wherein the effective amount of alcohol additive is in the range of 1 wt % to 12 wt %, preferably greater than 1 wt % to 10 wt %, and wherein the alcohol additive is one or more of ethanol, isopropyl alcohol, tert-butyl alcohol, propylene glycol, methanol, 1-propanol, 1-butanol, 1,3-butanediol, or hexylene glycol.

12. The composition of claim 10, wherein the effective amount of hydrotrope is in the range of 0.1 wt % to 5 wt % and wherein the hydrotrope is one or more of sodium xylene sulfonate, sodium cumene sulfonate, or sodium toluene sulfonate.

13. The composition of claim 10, wherein the anti-oxidant additive is in the range of 0.1 wt % to 3.0 wt % and wherein the anti-oxidant additive is one or more of tert butylhydroquinone (TBHQ), butylated hydroxyanisole (BHA), butylated hydroxytoluene (BHT), citrate, Vitamin A, Vitamin C, Vitamin D, or Vitamin E.

14. The composition of claim 10, wherein the additive also reduces the formation of 1,4-dioxane in the alkyl ether sulfate composition.

15. An alkyl ether sulfate surfactant composition comprising:
(a) from 1 wt % to 25 wt % of alkyl ether sulfate actives, wherein the alkyl ether sulfate surfactant comprises two or more ethylene oxide units;
(b) one or more additives selected from the group consisting of alcohols, hydrotropes, and anti-oxidants, wherein the one or more additives are in an amount effective to reduce formation of diethylene glycol monosulfate in the alkyl ether sulfate surfactant composition compared to the same alkyl ether sulfate surfactant composition without the additive; and
(c) water to total 100% of the composition.

16. The composition of claim 15, wherein the effective amount of alcohol additive is in the range of 1 wt % to 5 wt % and wherein the alcohol additive has a molecular weight of less than 200.

17. The composition of claim 16, wherein the alcohol additive is one or more of ethanol, isopropyl alcohol, tert-butyl alcohol, propylene glycol, methanol, 1-propanol, 1-butanol, 1,3-butanediol, or hexylene glycol.

18. The composition of claim 15, wherein the effective amount of hydrotrope is in the range of 0.1 wt % to 5 wt % and wherein the hydrotrope is one or more of sodium xylene sulfonate, sodium cumene sulfonate, or sodium toluene sulfonate.

19. The composition of claim 15, wherein the effective amount of anti-oxidant additive is in the range of 0.1 wt % to 3.0 wt % and wherein the anti-oxidant additive is one or more of tert butylhydroquinone (TBHQ), butylated hydroxyanisole (BHA), butylated hydroxytoluene (BHT), citrate, Vitamin A, Vitamin C, Vitamin D, or Vitamin E.

20. The composition of claim 15, wherein the additive also reduces formation of 1,4-dioxane in the alkyl ether sulfate surfactant composition.
